(19) United States
(12) Patent Application Publication
(10) Pub. No.: US 2005/0011493 A1
(43) Pub. Date: Jan. 20, 2005

(54) Accelerator pedal unit

(75) Inventor: Christian Reimann, Wehrheim (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 10/918,554

(22) Filed: Aug. 16, 2004

Related U.S. Application Data
(63) Continuation of application No. PCT/DE03/00441, filed on Feb. 13, 2003.

(30) Foreign Application Priority Data
Feb. 27, 2002 (DE) 102 08 504.8

(51) Int. Cl. F02D 11/10; G05G 1/14

(52) U.S. Cl. 123/399; 74/513

(57) ABSTRACT

The present invention realtes to an accelerator pedal unit including a pedal, a return spring connected to the pedal, and a coupling element mounted on the pedal and connected to a permanent magnet rotor of a rotary magnet.

### CROSS REFERENCE TO RELATED APPLICATIONS

The present application is a continuation of international application PCT/DE03/00441, filed Feb. 13, 2003, which designated the United States and further claims priority to German application 10208504.8, the both of which are herein incorporated by reference.

### BACKGROUND OF THE INVENTION

The invention relates to an accelerator pedal unit. Accelerator pedal units are known. They are generally composed of the pedal, a restoring spring which is connected to the pedal, and a coupling element which is arranged on the pedal, and are provided with further structural parts. A number of accelerator pedal units have here an advantageous arrangement of a roller belt which is connected via further elements to an electric motor which counteracts a depressing movement against the pedal. This permits an additional foot-activated resistor to be set in order to provide the driver of a motor vehicle with additional information about the current driving situation. However, in these accelerator pedal units it is disadvantageous that fluctuations occur in the torque values when plotted against time. The term used in this context is torque ripple, which has a disruptive effect when the pedal is operated. In addition, with these accelerator pedal units it is disadvantageous that transmissions have to be made to be relatively complex in terms of structure.

EP 0 617 674 describes an accelerator pedal unit in which there is no disadvantegeous torque ripple. However, it is disadvantegeous here that an additional resistance when the pedal is depressed cannot be set. The restoring force F is exerted here by a servo-motor.

### SUMMARY OF THE INVENTION

The invention is based on the object of providing an accelerator pedal unit in which a torque ripple can very largely be avoided in a relatively simple way. In this context, there is to be no additional space requirement or any need for complex transmission units.

The object on which the invention is based is achieved by means of an accelerator pedal unit which is composed of a pedal, a restoring spring which is connected to the pedal, and a coupling element which is arranged on the pedal and which is connected to a permanent magnet rotor of a rotary magnet. The rotary magnets which are to be used here are known. They are generally composed of a virtually U-shaped iron core which has, on its side facing away from the slit, a coil which is supplied with electrical current. The permanent magnet rotor whose permanent magnet experiences an induction through the coil is rotatably mounted between the coil and the slit in the iron core. By means of the current strength it is thus possible to set the resistance which counteracts a rotary movement of the permanent magnet rotor. The coupling element can advantageously be connected to the permanent magnet rotor using, for example, a joint and a lever arm which is arranged on this joint.

It has surprisingly been found that the torque ripple can be avoided if the coupling element is connected to a permanent magnet rotor of a rotary magnet. It is then advantageously possible to dispense with the arrangement of structurally complex transmission parts here. In this way, the accelerator pedal unit can be structurally configured in a relatively simple way.

One preferred configuration of the invention consists in the fact that the rotary magnet is connected to a control device for controlling power. The power control is advantageously carried out here by means of the current supply of the coil of the rotary magnet.

According to a further preferred configuration of the invention, the rotary magnet is connected via a position sensor, which directly senses the position of the permanent magnet rotor, to a control device for controlling power. In this context, the position sensor advantageously continuously senses the espective position of the permanent magnet rotor and passes on this information directly to the control device. Depending on the respective position of the permanent magnet rotor, the control device then directly controls the current supply of the coil so that an additional foot-operated resistance can be set in a relatively simple way.

According to a further preferred refinement of the invention there is provision for the control device to be connected to another position sensor which directly senses the position of the pedal. This other position sensor may also additionally be arranged here. This other position sensor supplies the control device directly with the necessary information about the present position of the pedal so that the rotary magnet can be actuated directly as a function of the position of the pedal.

A further preferred embodiment of the invention consists in the fact that current is applied directly to the coil of the rotary magnet from the control device via a current supply. The direct application of current from the control device permits relatively rapid adaptation of the level of electric current as a function of the respective position of the pedal.

### BRIEF DESCRIPTION OF THE SEVERAL VIEWS OF THE DRAWINGS

The invention will be explained below in more detail and by way of example with reference to the drawings.

FIG. 1 shows an accelerator pedal unit with pedal, bearing, restoring spring and rotary magnet.

### DETAILED DESCRIPTION OF THE INVENTION

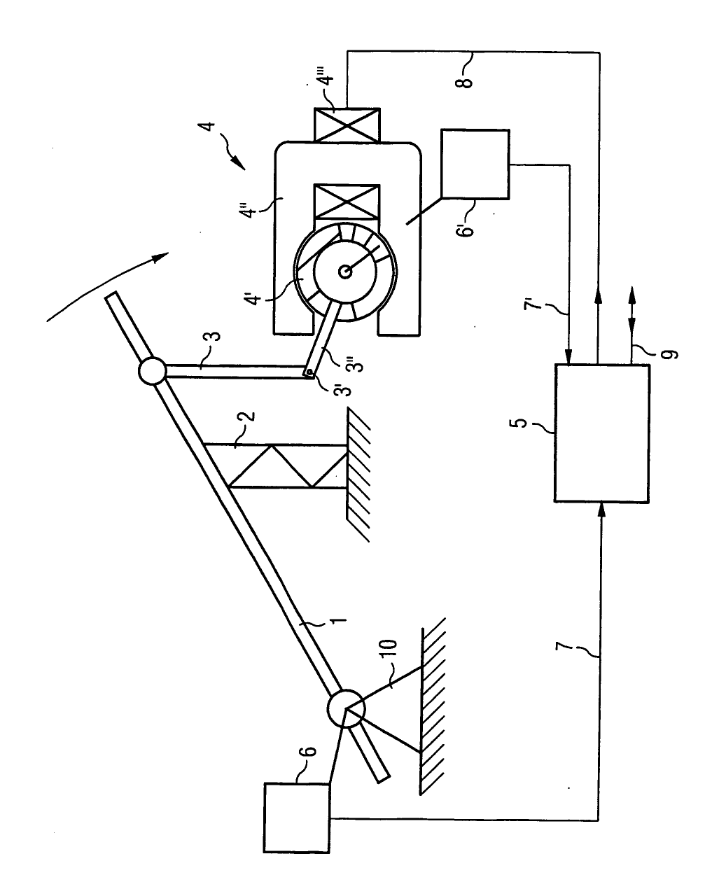

In FIG. 1, an accelerator pedal unit is illustrated in a side view. The accelerator pedal unit is composed of a pedal 1 which is mounted at one end on a bearing 10.

The pedal 1 is connected to a restoring spring 2. This restoring spring 2 causes the pedal 1 to be restored to the home position if no further force is exerted on the pedal 1.

A coupling element 3, which is connected via a bearing 3′ and a lever arm 3″ to a permanent magnet rotor 4′ of a rotary magnet 4 is arranged on the pedal 1. The rotary magnet 4 has a U-shaped iron core 4″ on which a coil 4′″ is arranged on the side arranged opposite the slit. The permanent magnet rotor 4′ is rotatably mounted between the slit in the iron core 4″ and the coil 4′″. Electric current is applied to the coil 4′″ via the current supply 8 and induces the permanent magnet rotor 4′ of the rotary magnet 4. In this way, the rotational resistance of the permanent magnet rotor 4′ can be set depending on the level of the current strength. This is equivalent to setting an additional foot-operated resistance in order to provide the driver of a motor vehicle with additional information about the present driving situation. It is advantageous here if this can be achieved without arranging structurally complex transmission elements. The rotary magnet 4 is connected via a position sensor 6′, which directly senses the position of the permanent magnet rotor 4′, to a control device 5 for controlling power, via the line 7′. In this way, the control device 5 can apply the desired current strength to the coil 4′″ directly as a function of the respective position of the permanent magnet rotor 4′. Furthermore, the control device 5 is connected to another position sensor 6 which directly senses the position of the pedal 1. In this way, the control device 5 is provided with additional information about the position of the pedal 1. However, in some cases, it may be sufficient optionally to arrange the one position sensor 6′ or the other position sensor 6 which is connected to the control device 5 via the line 7. Further information relating to the actuation of the coil 4′″ can be exchanged via the line 9.

1. An accelerator pedal unit comprising:
a pedal,
a restoring spring connected to the pedal,
a rotary magnet including a permanent magnet rotor, the rotary magnet arranged proximate to the pedal; and
a coupling element arranged on the pedal and connected to the permanent magnet rotor.

2. The accelerator pedal unit according to claim 1, further comprising a control device for controlling power, the control device connected to the rotary magnet.

3. The accelerator pedal unit according to claim 2, further comprising a position sensor arranged to detect a position of the permanent magnet rotor, the position sensor facilitating a connection between the rotary magnet and the control device.

4. The accelerator pedal unit according to claim 1, further comprising another position sensor arranged to detect a position of the pedal, the another position sensor connected to the control device.

5. The accelerator pedal unit according to claim 2, further comprising another position sensor arranged to detect a position of the pedal, the another position sensor connected to the control device.

6. The accelerator pedal unit according to claim 3, further comprising another position sensor arranged to detect a position of the pedal, the another position sensor connected to the control device.

7. The accelerator pedal unit according to claim 1, further comprising a current supply and means for applying a current from the current supply directly to a coil of the rotary magnet from the control device.

8. The accelerator pedal unit according to claim 2, further comprising a current supply and means for applying a current from the current supply directly to a coil of the rotary magnet from the control device.

9. The accelerator pedal unit according to claim 3, further comprising a current supply and means for applying a current from the current supply directly to a coil of the rotary magnet from the control device.

10. The accelerator pedal unit according to claim 4, further comprising a current supply and means for applying a current from the current supply directly to a coil of the rotary magnet from the control device.

11. The accelerator pedal unit according to claim 5, further comprising a current supply and means for applying a current from the current supply directly to a coil of the rotary magnet from the control device.

12. The accelerator pedal unit according to claim 6, further comprising a current supply and means for applying a current from the current supply directly to a coil of the rotary magnet from the control device.
